(19) United States
(12) Patent Application Publication
(10) Pub. No.: US 2008/0257790 A1
(43) Pub. Date: Oct. 23, 2008

(54) SANITARY SPOUT VALVE

(75) Inventor: Joseph L. Smith, Cincinnati, OH (US)

Correspondence Address: LEGAL DEPT., IP GROUP;M-I L.L.C., 5950 NORTH COURSE DRIVE, HOUSTON, TX, 77072, US

(73) Assignee: M-I L.L.C., Houston, TX (US)

(21) Appl. No.: 12/104,000

(22) Filed: Apr. 16, 2008

Related U.S. Application Data
(60) Provisional application No. 60/912,969, filed on Apr. 20, 2007.

(51) Int. Cl. B07B 11/06

(52) U.S. Cl. 209/258

(57) ABSTRACT

The instant disclosure is directed to a valve for a separatory shaker comprises a movable plate wherein at least a portion of the plate is dimensioned and arranged to fit in physical communication with, and be removably attached to a sidewall of a separatory shaker, the plate comprising a first portion which is dimensioned and arranged such that the plate may be positioned in physical communication with and adjacent to the sidewall to obstruct at least a portion of the spout opening, the plate further comprising a second portion having a valve opening there through, the valve opening being dimensioned and arranged within the second portion of the plate such that the plate may be positioned in physical communication with and adjacent to the sidewall to allow fluid communication between the spout and the screening chamber through the spout opening. A method of separating a plurality of particles is also disclosed.

### CROSS-REFERENCE TO RELATED APPLICATIONS

This application claims priority to U.S. Provisional Patent Application No. 60/912,969, filed Apr. 20, 2007, the disclosure of which is incorporated herein by reference.

### BACKGROUND OF INVENTION

1. Field of the Invention

This invention relates to a valve for a separatory screening apparatus.

2. Background Art

Vibratory separators have long been used for the multiple separation of materials, both wet and dry. The geometries of such separators include rectangular screen separators and circular screen separators. Each type of separator has its own advantages and are well known in the art.

Screen separators include a housing, within which one or more screening chambers or cavities are defined. The screening chamber is bound on the sides by a sidewall, and on the top and/or the bottom by a screening element. Each of the internal chambers includes a discharge port, also referred to as a spout, in fluid communication with the screening chamber through an opening in the sidewall.

The spout typically includes an arm extending radially away from the sidewall. Material of a size which does not pass through screening element may flow out of the separator via the spout.

The screening chambers may be built up by several sections which are stacked one upon another with screens located there between. The entire assembly is then securely clamped with clamp bands and/or the like to hold the assembly together during vibration.

The housing is typically mounted on a plurality of resilient members, typically springs, and is in physical communication with a vibration generator. The vibration generator may include an electric motor comprising one or more eccentrically mounted weights. Rotation of the motor generates vibration which in turn causes the separator to vibrate, thus enhancing the screening separation within the screening chamber.

Applications which utilize screening separators may require the material being screened to remain within a particular screening chamber for a period of time. This may be accomplished by screen geometry, wherein the material being screened must traverse one or more hills and valleys before exiting the separator through the spout. Valves that block the exit holes of the spouts may also be employed for this purpose. However, such valves add mass to the spout and may result in fatigue of the joint between the spout arm and the sidewall. In addition, material may accumulate within “dead zones” within the spout which may result in cross contamination or cleanup issues. Spout valves may also require disassembly of the separator to operate, which requires down time and the possibility of inducing contamination within the system.

Numerous challenges related to spout valves exist. A need exists for a spout valve which does not add additional mass to the spout arm, and/or which does not result in accumulation of materials within the spout, and/or which does not require disassembly to operate.

### SUMMARY OF INVENTION

In a first aspect of the present invention, a valve for a separatory shaker of the type having a spout in fluid communication with a screening chamber of the separatory shaker through a spout opening disposed through a sidewall of the separatory shaker is disclosed. The valve includes a movable plate wherein at least a portion of the plate is dimensioned and arranged to fit in physical communication with, and be removably attached to the sidewall. The plate includes a first portion which is dimensioned and arranged such that the plate may be positioned in physical communication with and adjacent to the sidewall to obstruct at least a portion of the spout opening. The plate further includes a second portion having a valve opening there through, the valve opening being dimensioned and arranged within the second portion of the plate such that the plate may be positioned in physical communication with and adjacent to the sidewall to allow fluid communication between the spout and the screening chamber through the spout opening, wherein the plate is movable in a plurality of positions including a closed position, wherein the first portion of the plate is arranged in communication with the sidewall to obscure essentially all of the spout opening such that the fluid communication between the spout and the screening chamber is essentially obscured by the plate, and an open position, wherein the second portion of the plate is arranged in communication with the sidewall such that the fluid communication between the spout and the screening chamber through the spout opening is not obscured by the plate.

In another aspect of the present invention, a valve for a separatory shaker of the type having a spout in fluid communication with a screening chamber of the separatory shaker through a spout opening disposed through a sidewall of the separatory shaker, the sidewall having an outer side and an inner side is disclosed, wherein the valve includes a movable plate dimensioned and arranged to fit within at least a portion of the screening chamber, wherein at least a portion of the plate is in physical communication with the inner side of the sidewall, and wherein at least a portion of the plate is removably attached to the sidewall. The plate includes a first portion which is dimensioned and arranged such that the plate may be positioned within the screening chamber adjacent to the sidewall to obstruct at least a portion of the spout opening, The plate further includes a second portion having a valve opening there through, the valve opening being dimensioned and arranged within the second portion of the plate such that the plate may be positioned within the screening chamber adjacent to the sidewall to allow fluid communication between the spout and the screening chamber through the spout opening, wherein the plate is movable within the screening chamber in a plurality of positions including a closed position, wherein the first portion of the plate is arranged within the screening chamber adjacent to the sidewall to obscure essentially all of the spout opening such that the fluid communication between the spout and the screening chamber is essentially obscured by the plate, and an open position, wherein the second portion of the plate is arranged within the screening chamber adjacent to the sidewall such that the fluid communication between the spout and the screening chamber through the spout opening is not obscured by the plate.

In yet another aspect of the present invention, a valve for a circular separatory shaker of the type having a spout in fluid communication with a circular screening chamber radially disposed about a central axis of the separatory shaker through a spout opening disposed through a sidewall of the separatory shaker, the sidewall having an outer side and an inner side is disclosed, wherein the valve includes a continuous movable plate dimensioned and arranged radially about the central axis to fit within at least a portion of the screening chamber, coaxial to the sidewall, wherein at least a portion of the plate is in physical communication with the inner side of the sidewall, and wherein at least a portion of the plate attachable to the sidewall. The plate includes a first portion which is dimensioned and arranged such that the plate may be positioned within the screening chamber to obstruct at least a portion of the spout opening. The plate further includes a second portion having a valve opening there through, the valve opening being dimensioned and arranged within the second portion of the plate such that the plate may be positioned within the screening chamber to allow fluid communication between the spout and the screening chamber through the spout opening, wherein the plate is movable radially about the central axis and within the screening chamber in a plurality of positions including a closed position, wherein the first portion of the plate is arranged within the screening chamber to obscure essentially all of the spout opening such that the fluid communication between the spout and the screening chamber is essentially obscured, and an open position, wherein the second portion of the plate is arranged within the screening chamber such that the fluid communication between the spout and the screening chamber through the spout opening is not obscured by the plate.

In yet another aspect of the invention, a method to separate a plurality of particles includes the steps of contacting the plurality of particles with a screen within a screening chamber of a separatory shaker, wherein a portion of the particles is retained on a surface of the screen and a portion of the particles flows through the screen, wherein the separatory shaker comprises a spout in fluid communication with a screening chamber of the separatory shaker through a spout opening disposed through a sidewall of the separatory shaker, and wherein the separatory shaker comprises a valve. The valve includes a movable plate wherein at least a portion of the plate is dimensioned and arranged to fit in physical communication with, and be removably attached to the sidewall, the plate includes a first portion which is dimensioned and arranged such that the plate may be positioned in physical communication with and adjacent to the sidewall to obstruct at least a portion of the spout opening, the plate further comprising a second portion having a valve opening there through, the valve opening being dimensioned and arranged within the second portion of the plate such that the plate may be positioned in physical communication with and adjacent to the sidewall to allow fluid communication between the spout and the screening chamber through the spout opening, wherein the plate is movable in a plurality of positions including a closed position, wherein the first portion of the plate is arranged in communication with the sidewall to obscure essentially all of the spout opening such that the fluid communication between the spout and the screening chamber is essentially obscured by the plate, and an open position, wherein the second portion of the plate is arranged in communication with the sidewall such that the fluid communication between the spout and the screening chamber through the spout opening is not obscured by the plate

These and other features, aspects and advantages of the present invention will become better understood with reference to the following drawings, description and claims.

### BRIEF DESCRIPTION OF THE DRAWINGS

FIG. 1 is a perspective view of an embodiment of the valve according to the instant disclosure:

FIG. 2 is a perspective view of another embodiment of the valve according to the instant disclosure;

FIG. 3 is a perspective view of another embodiment of the valve according to the instant disclosure;

FIG. 4 is a perspective view of a screen separator comprising the instant valve in a closed position;

FIG. 5 is a perspective view of a screen separator comprising the instant valve in an open position;

FIG. 6 is a cross sectional view of the instant valve in the open position, assembled in a separatory shaker; and

FIG. 7 is a cross sectional view of a plurality of the instant valves assembled in a separatory shaker.

### DETAILED DESCRIPTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

In the following description, numerous specific details are set forth to provide a thorough understanding of the present invention. However, it will be obvious to those skilled in the art that the present invention may be practiced without such specific details. In other instances, well-known devices have been shown in block diagram form in order not to obscure the present invention in unnecessary detail. For the most part, details unnecessary to obtain a complete understanding of the present invention have been omitted in as much as such details are within the skills of persons of ordinary skill in the relevant art.

Broadly, the present invention generally provides for a valve for a separatory shaker. In an embodiment, the valve comprises a movable plate dimensioned and arranged to fit within at least a portion of a screening chamber of a separatory shaker, wherein at least a portion of the plate is in physical communication with, and removably attachable to a sidewall of the screening chamber. The plate of the valve comprises a first portion which is dimensioned and arranged such that the plate may be positioned adjacent to the sidewall to obstruct at least a portion of a spout opening, which provides fluid communication between an outlet spout of the screening chamber, and the screening chamber itself. The plate further comprises a second portion having a valve opening there through, the valve opening being dimensioned and arranged within the second portion of the plate such that the plate may be positioned adjacent to the sidewall to allow fluid communication between the spout and the screening chamber through the spout opening. Preferably, the plate is movable in a plurality of positions including a closed position, wherein the first portion of the plate is arranged in communication with the sidewall to obscure essentially all of the spout opening such that the fluid communication between the spout and the screening chamber is essentially obscured by the plate, and an open position, wherein the second portion of the plate is arranged in communication with the sidewall such that the fluid communication between the spout and the screening chamber through the spout opening is not obscured by the plate.

As used herein, the term fluid communication implies the ability of the particles or material being screen separated to flow through a particular opening. Accordingly, wherein the first portion of the plate is arranged in the closed position such that the plate is in communication with the sidewall to obscure essentially all of the spout opening such that the fluid communication between the spout and the screening chamber is essentially obscured by the plate, the spout opening need merely be blocked (i.e., obscured) such that the material being screened is not able to pass from the screening chamber through the spout opening. The spout opening need not be blocked such that it is impermeable to gases, liquids, or the like, but need only stop at least a portion of the material being screened from passing from the screening chamber through the spout opening.

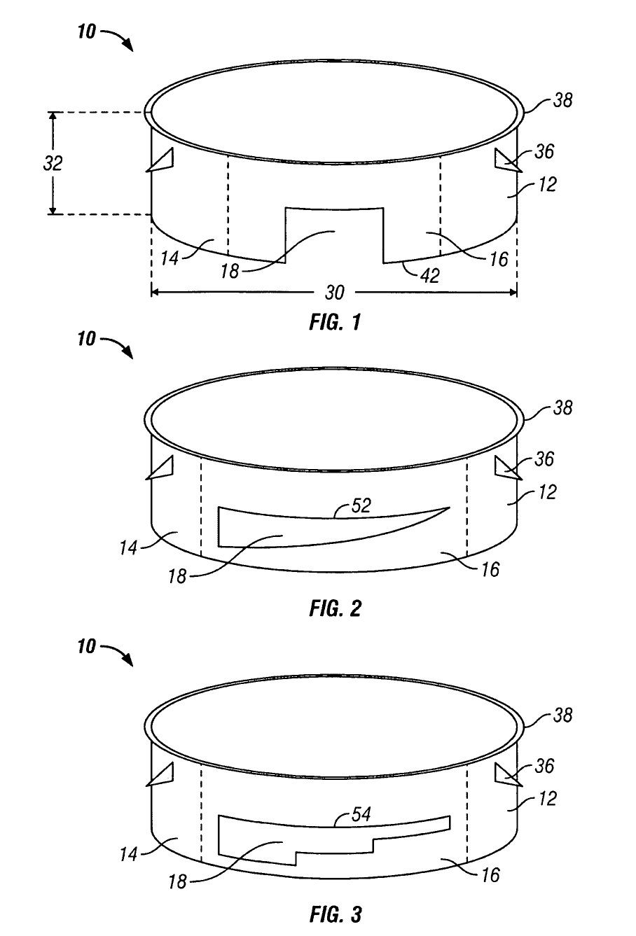

Turning now to the drawings, depicted elements are not necessarily shown to scale and like or similar elements are designated by the same reference numeral through the several views. FIG. 1 shows an embodiment of the valve of the instant disclosure, represented generally as 10. Valve 10 comprising a plate 12 comprising a first portion 14 which is dimensioned and arranged such that the plate may be positioned adjacent to a sidewall 20 of a separatory shaker 22 (See FIG. 4) to obstruct at least a portion of a spout opening 24 (See FIG. 5), which provides fluid communication between an outlet spout 26 and screening chamber 28. Plate 12 further includes a second portion 16 having a valve opening 18 disposed through plate 12. Valve opening 18 being dimensioned and arranged within second portion 16 of plate 12 such that plate 12 may be positioned adjacent to a sidewall 20 (See FIG. 5) to allow fluid communication between spout 26 and screening chamber 28 through spout opening 24 (see FIG. 5.) In an embodiment, plate 12 is movable in a plurality of positions including a closed position (shown in FIG. 4) wherein first portion 14 is arranged in communication with sidewall 20 to obscure essentially all of spout opening 24 such that fluid communication between spout 26 and screening chamber 28 is essentially obscured by plate 12. In an embodiment, plate 12 is also movable in an open position (shown in FIG. 5), wherein second portion 16 is arranged in communication with sidewall 20 such that the fluid communication between spout 26 and screening chamber 28 through spout opening 24 is not obscured by plate 12.

In the embodiment shown in FIG. 1, plate 12 includes a continuous member having a circular cross section, which would be appropriate for use in a separatory shaker having a similar cross section. Plate 12 may form a continuous surface which models the sidewall of the separatory shaker within which valve 10 is utilized, or may form only a portion of the sidewall of the separatory shaker within which valve 10 is utilized. Accordingly, plate 12 may comprise a discontinuous surface which models a portion of the sidewall of the separatory shaker. Valve 10 is not limited as to the cross-sectional shape, but need merely at least partially correspond to the cross-sectional shape of the separatory shaker within which valve 10 is utilized.

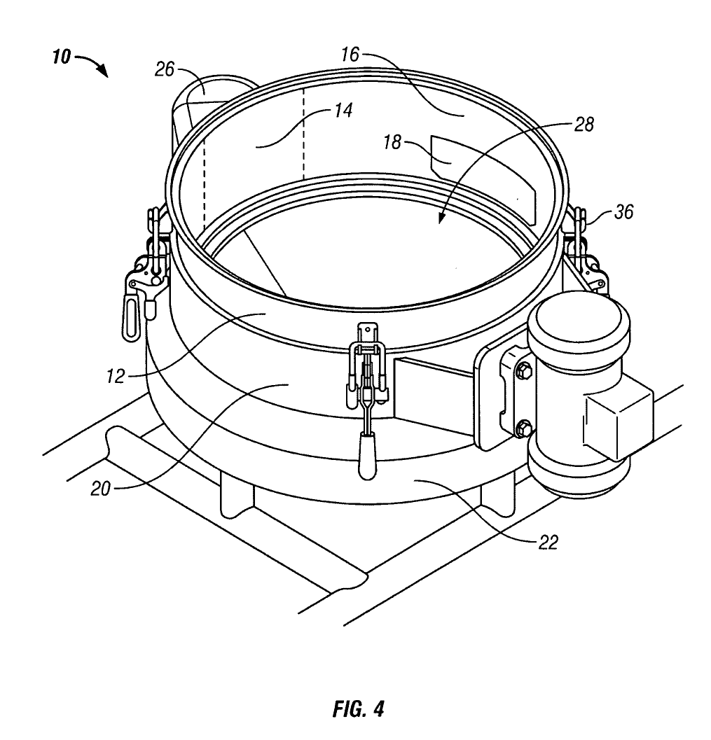

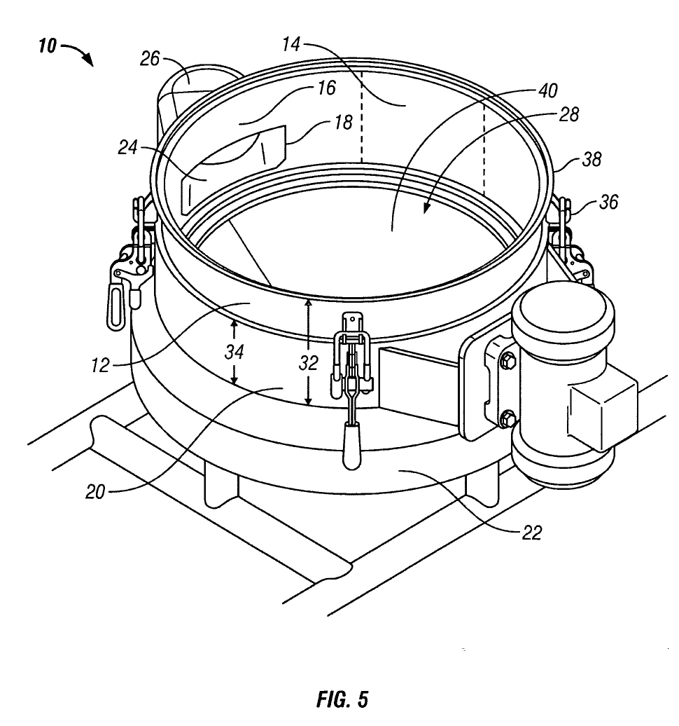

As shown in the embodiments of FIGS. 2 and 3, valve opening 18 may have a variable area such that valve 10 may act as a weir within a separatory shaker. Valve opening 18 may have a continuously variable opening 52 (FIG. 2), or valve opening may comprise a plurality of discrete steps 54 (FIG. 3.)

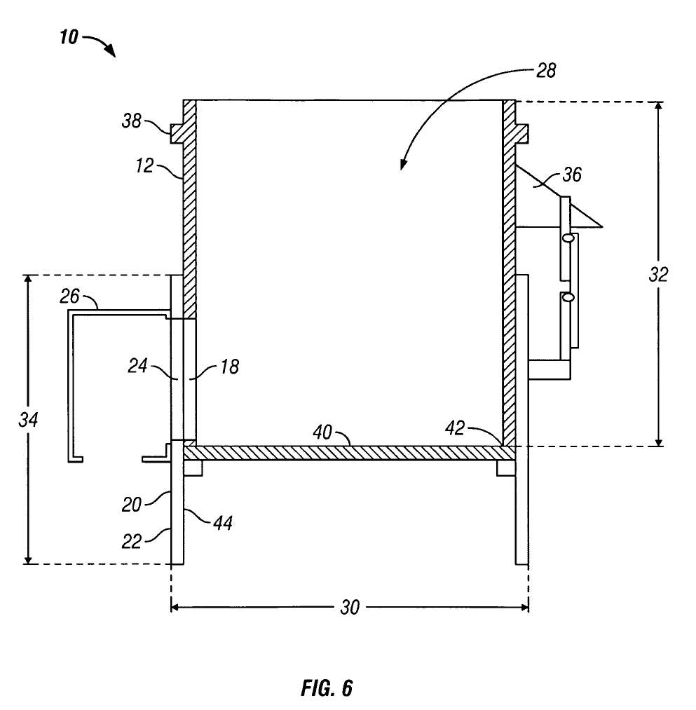

As shown in the embodiment in FIG. 6, valve 10 may have a circular cross-sectional shape and be utilized within a separatory shaker having a corresponding cross-sectional shape. Valve 10 preferably has an outer diameter 30 dimensioned such that valve 10 fits inside a sidewall 20 if a separatory shaker 22. Preferably, outer diameter 30 is dimensioned such that at least a portion of plate 12 is in physical communication with an inner side 44 of sidewall 20. Accordingly, the cross-sectional shape and dimensions of outer diameter 30 depend on the separatory shaker within which the instant valve is used. In the preferred embodiment, valve 10 may be used in a circular separatory shaker of the type having a spout in fluid communication with a circular screening chamber radially disposed about a central axis of the separatory shaker through a spout opening disposed through a sidewall of the separatory shaker, wherein the sidewall has an outer side and an inner side. In this embodiment, the valve preferably comprises a continuous movable plate dimensioned and arranged radially about a central axis to fit within at least a portion of the screening chamber, coaxial to the sidewall, wherein at least a portion of the plate is in physical communication with the inner side of the sidewall, and wherein at least a portion of the plate attachable to the outer side of the sidewall.

As shown in FIG. 6, valve 10 preferably has a valve height 32 which is larger than the sidewall height 34 of the sidewall 20 of the separatory shaker 22 within which valve 10 is used. In and embodiment, valve 10 may include one or more attachment means 36, which include clips, flanges, hooks and the like, which allow for valve 10 to be secured to the separatory shaker 22 within which valve 10 is used. The attachment means are preferably located external to the vibratory shaker (i.e., external to screening chamber 28) such that they may be engaged and/or released without having to disassemble the separatory shaker. In an embodiment wherein the cross-sectional shape is round, upon release of the attachment means, the valve may be rotated to open, to close, and/or to partially close the valve and then the valve subsequently reattached using the attachment means. Accordingly, the valve may be opened or closed without requiring disassembly of the separatory shaker.

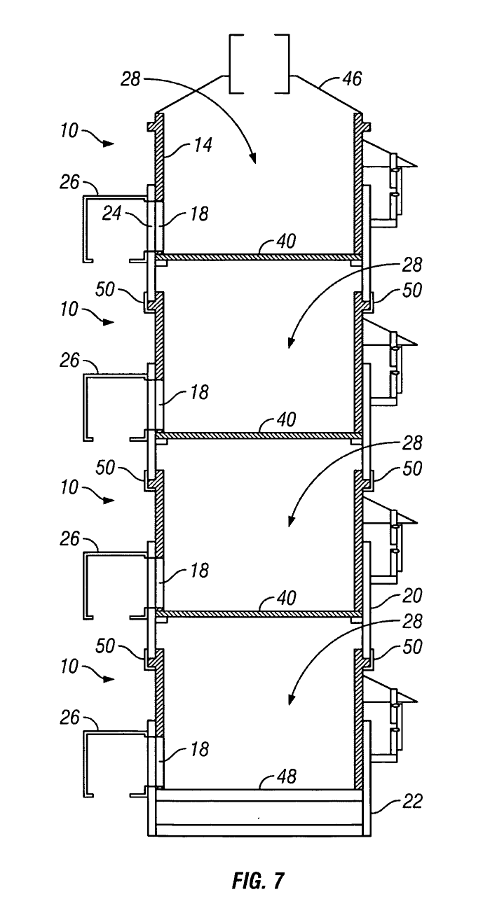

Valve 10 may further include a top lip 38 dimensioned and arranged to receive another screen assembly 40, another sidewall 20, or other fitting and/or adapter such as an inlet port of the separatory shaker as shown in FIG. 7 such that a plurality of assemblies including sidewall 20 to which valve 10 is attached may be stacked one on top of the other and attached to one another using clamps 50, flanges, and/or other attachment means known in the art. As shown in FIG. 7, valve 10 may also be utilized on the final stage of the separatory shaker, wherein an end plate 48 replaces the screen assembly 40.

As shown in the embodiment of FIG. 6, valve 10 has a bottom side 42 which is located in physical contact with a top portion of a screen assembly 40, located within screening chamber 28, wherein bottom side 42 is biased against the top of screen assembly 40. As such, valve 10 may provide a means of holding screen assembly 40 in place within the separatory shaker. Preferably, screen assembly 40 comprises a screen element mounted to a screen frame. In another embodiment, screen assembly 40 may comprise a perforated plate, and/or any semi-permeably membrane designed to stratify materials based on their physical size.

Accordingly, the instant valve does not add additional mass to the spout arm. The instant valve also does not result in accumulation of materials within the spout. By locating the attachment means external to the vibratory shaker, the valve may be rotated and thus opened or closed without requiring disassembly of the separatory shaker.

In an embodiment, a method to separate a plurality of particles comprises the steps of contacting the plurality of particles with a screen within a screening chamber of a separatory shaker, wherein a portion of the particles is retained on a surface of the screen and a portion of the particles flows through the screen, wherein the separatory shaker comprises a spout in fluid communication with a screening chamber of the separatory shaker through a spout opening disposed through a sidewall of the separatory shaker, wherein the separatory shaker comprises a valve of the instant disclosure. In an embodiment, the valve may be in the closed position, in the open position, or at least partially in the open position.

In another embodiment, the valve comprises a top lip dimensioned and arranged to receive another screen assembly, another sidewall, a fitting, and/or an adapter of the separatory shaker, and the separatory shaker comprises a plurality of valves in physical communication with a plurality of side walls, each stacked one on top of the other. In another embodiment, at least one of the plurality of valves is in the closed position, at least one of the plurality of valves is in the open position, or a combination thereof.

It should be understood, of course, that the foregoing relates to preferred embodiments of the invention and that modifications may be made without departing from the spirit and scope of the invention as set forth in the following claims.

What is claimed:

1. A valve for a separatory shaker of the type having a spout in fluid communication with a screening chamber of the separatory shaker through a spout opening disposed through a sidewall of the separatory shaker, the valve comprising:
a movable plate wherein at least a portion of the plate is dimensioned and arranged to fit in physical communication with, and be removably attached to the sidewall;
the plate comprising a first portion which is dimensioned and arranged such that the plate may be positioned in physical communication with, and adjacent to, the sidewall to obstruct at least a portion of the spout opening, the plate further comprising a second portion having a valve opening there through, the valve opening being dimensioned and arranged within the second portion of the plate such that the plate may be positioned in physical communication with, and adjacent to, the sidewall to allow fluid communication between the spout and the screening chamber through the spout opening, wherein the plate is movable in a plurality of positions including a closed position, wherein the first portion of the plate is arranged in communication with the sidewall to obscure essentially all of the spout opening such that the fluid communication between the spout and the screening chamber is essentially obscured by the plate, and an open position, wherein the second portion of the plate is arranged in communication with the sidewall such that the fluid communication between the spout and the screening chamber through the spout opening is not obscured by the plate.

2. The valve of claim 1, wherein the valve is dimensioned and arranged to fit within the screening chamber of the separatory shaker.

3. The valve of claim 1, wherein the valve opening comprises a continuously variable opening.

4. The valve of claim 1, wherein the valve opening comprises a plurality of discrete steps.

5. The valve of claim 1, wherein the plate comprises a continuous surface which models the sidewall of the separatory shaker.

6. The valve of claim 1, wherein the valve is removably attachable to the sidewall using an attachment means selected from the group consisting of clips, flanges, hooks, and combinations thereof.

7. The valve of claim 1, wherein the valve further comprises a bottom side which is locatable within the screening chamber of the separatory shaker to be in physical contact with a top portion of a screen assembly and be biased against the top portion of the screen assembly.

8. The valve of claim 1, further comprising a top lip dimensioned and arranged to receive a screen assembly, another sidewall, a fitting, and/or an adapter of the separatory shaker.

9. A valve for a separatory shaker of the type having a spout in fluid communication with a screening chamber of the separatory shaker through a spout opening disposed through a sidewall of the separatory shaker, the sidewall having an outer side and an inner side, the valve comprising:
a movable plate dimensioned and arranged to fit within at least a portion of the screening chamber, wherein at least a portion of the plate is in physical communication with the inner side of the sidewall, and wherein at least a portion of the plate is removably attached to the sidewall;
the plate comprising a first portion which is dimensioned and arranged such that the plate may be positioned within the screening chamber adjacent to the sidewall to obstruct at least a portion of the spout opening, the plate further comprising a second portion having a valve opening there through, the valve opening being dimensioned and arranged within the second portion of the plate such that the plate may be positioned within the screening chamber adjacent to the sidewall to allow fluid communication between the spout and the screening chamber through the spout opening, wherein the plate is movable within the screening chamber in a plurality of positions including a closed position, wherein the first portion of the plate is arranged within the screening chamber adjacent to the sidewall to obscure essentially all of the spout opening such that the fluid communication between the spout and the screening chamber is essentially obscured by the plate, and an open position, wherein the second portion of the plate is arranged within the screening chamber adjacent to the sidewall such that the fluid communication between the spout and the screening chamber through the spout opening is not obscured by the plate.

10. The valve of claim 9, wherein the valve opening comprises a continuously variable opening.

11. The valve of claim 9, wherein the valve opening comprises a plurality of discrete steps.

12. The valve of claim 9, wherein the plate comprises a continuous surface which models the sidewall of the separatory shaker.

13. The valve of claim 9, wherein the valve is removably attachable to the sidewall using an attachment means selected from the group consisting of clips, flanges, hooks, and combinations thereof.

14. The valve of claim 9, wherein the valve further comprises a bottom side which is locatable within the screening chamber of the separatory shaker to be in physical contact with a top portion of a screen assembly and be biased against the top portion of the screen assembly.

15. The valve of claim 9, further comprising a top lip dimensioned and arranged to receive a screen assembly, another sidewall, a fitting, and/or an adapter of the separatory shaker.

16. A valve for a circular separatory shaker of the type having a spout in fluid communication with a circular screening chamber radially disposed about a central axis of the separatory shaker through a spout opening disposed through a sidewall of the separatory shaker, the sidewall having an outer side and an inner side, the valve comprising:
a continuous movable plate dimensioned and arranged radially about the central axis to fit within at least a portion of the screening chamber, coaxial to the sidewall, wherein at least a portion of the plate is in physical communication with the inner side of the sidewall, and wherein at least a portion of the plate attachable to the sidewall;
the plate comprising a first portion which is dimensioned and arranged such that the plate may be positioned within the screening chamber to obstruct at least a portion of the spout opening, the plate further comprising a second portion having a valve opening there through, the valve opening being dimensioned and arranged within the second portion of the plate such that the plate may be positioned within the screening chamber to allow fluid communication between the spout and the screening chamber through the spout opening, wherein the plate is movable radially about the central axis and within the screening chamber in a plurality of positions including a closed position, wherein the first portion of the plate is arranged within the screening chamber to obscure essentially all of the spout opening such that the fluid communication between the spout and the screening chamber is essentially obscured, and an open position, wherein the second portion of the plate is arranged within the screening chamber such that the fluid communication between the spout and the screening chamber through the spout opening is not obscured by the plate.

17. The valve of claim 16, wherein the valve opening comprises a continuously variable opening.

18. The valve of claim 16, wherein the valve opening comprises a plurality of discrete steps.

19. The valve of claim 16, wherein the plate comprises a continuous surface which models the sidewall of the separatory shaker.

20. The valve of claim 16, wherein the valve is removably attachable to the sidewall using an attachment means selected from the group consisting of clips, flanges, hooks, and combinations thereof.

21. The valve of claim 16, wherein the valve further comprises a bottom side which is locatable within the screening chamber of the separatory shaker to be in physical contact with a top portion of a screen assembly and be biased against the top portion of the screen assembly.

22. The valve of claim 16, further comprising a top lip dimensioned and arranged to receive a screen assembly, another sidewall, a fitting, and/or an adapter of the separatory shaker.

23. A method to separate a plurality of particles comprising the steps of contacting the plurality of particles with a screen within a screening chamber of a separatory shaker, wherein a portion of the particles is retained on a surface of the screen and a portion of the particles flows through the screen, wherein the separatory shaker comprises a spout in fluid communication with a screening chamber of the separatory shaker through a spout opening disposed through a sidewall of the separatory shaker, and wherein the separatory shaker comprises a valve, the valve comprising:
a movable plate wherein at least a portion of the plate is dimensioned and arranged to fit in physical communication with, and be removably attached to the sidewall;
the plate comprising a first portion which is dimensioned and arranged such that the plate may be positioned in physical communication with and adjacent to the sidewall to obstruct at least a portion of the spout opening, the plate further comprising a second portion having a valve opening there through, the valve opening being dimensioned and arranged within the second portion of the plate such that the plate may be positioned in physical communication with and adjacent to the sidewall to allow fluid communication between the spout and the screening chamber through the spout opening, wherein the plate is movable in a plurality of positions including a closed position, wherein the first portion of the plate is arranged in communication with the sidewall to obscure essentially all of the spout opening such that the fluid communication between the spout and the screening chamber is essentially obscured by the plate, and an open position, wherein the second portion of the plate is arranged in communication with the sidewall such that the fluid communication between the spout and the screening chamber through the spout opening is not obscured by the plate.

24. The method of claim 23, wherein the valve is in the closed position.

25. The method of claim 23, wherein the valve is in the open position.

26. The method of claim 23, wherein the valve comprises a top lip dimensioned and arranged to receive another screen assembly, another sidewall, a fitting, and/or an adapter of the separatory shaker.

27. The method of claim 26, wherein the separatory shaker comprises a plurality of valves in physical communication with a plurality of side walls, each stacked one on top of the other.

28. The method of claim 27, wherein at least one of the plurality of valves is in the closed position.

29. The method of claim 27, wherein at least one of the plurality of valves is in the open position.
